(19) United States
(12) Patent Application Publication
(10) Pub. No.: US 2005/0085122 A1
(43) Pub. Date: Apr. 21, 2005

(54) Charger

(75) Inventor: Chyi-Ming Chiou, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Liung Feng Industrial Co., Ltd.

(21) Appl. No.: 10/685,502

(22) Filed: Oct. 16, 2003

(51) Int. Cl. H01R 3/00

(52) U.S. Cl. 439/500

(57) ABSTRACT

A charger is received in a portable electronic product, and electrically connects with internal circuit of the portable electronic product or outside charges the portable electronic product. The charger has a slider, a coil set assembled on the slider, and a magnet set. The magnet set is spaced a predetermined distance from the slider. Magnetic field varies quickly between coils of the coil set and magnets of the magnet set when the slider slides, thereby producing mass inductive current for power of the portable electronic product. And the charger is not constrained of special place and does not pollute the environment.

### BACKGROUND OF THE INVENTION

1. Field of the Invention

The present invention relates to a charger, and particularly to a charger performing electromagnetic induction to produce inductive current for charging portable electronic products, such as portable computer, Personal Digital Assistant (PDA), digital camera, electric torch, walkman and etc.

2. Related Art

Portable electronic products are developed with more functions, especially some of which need more rapid transmission speed and larger memory for Internet, and correspondingly requiring more power. This requirement becomes more outstanding with development of wide-band communication. Therefore, it is desired to supply power of portable electronic products timely for meeting consumers' need.

Replacing battery and charging are two ways to supply power of portable electronic products. Replacing battery is easy, but abandoned battery pollutes the environment. Moreover, it is not economic to replace battery frequently.

Although charging can overcome the deficiencies of replacing battery, it is always limited within a special place. cm

### SUMMARY OF THE INVENTION

Accordingly, an object of the present invention is to provide a charger which economically and continuously supplies electronic products with power, and which does not pollute environment.

Another object of the present invention is to provide a charger which charges quickly without outside batteries.

The charger performs electromagnetic induction of accelerated varying magnetic field to produce mass inductive current for power. The charger comprises a slider, a coil set assembled on the slider, and a magnet set spaced a predetermined distance from the slider. Magnetic field varies quickly between coils of the coil set and magnets of the magnet set when the slider slides, thereby producing mass inductive current.

The slider includes a fixing plate, a metal base and rolling elements. The metal base is surrounded by the coil set and connects with the fixing plate. The rolling elements are located at corners of the fixing plate for facilitating the slider to slide.

The charger has buffers on opposite sides of a moving path of the slider for urging the slider to reset after displacement.

### BRIEF DESCRIPTION OF THE DRAWINGS

FIG. 1 is an exploded perspective view of a charger according to a first embodiment of the present invention.

FIG. 2 is a partially assembled perspective view of the charger of FIG. 1.

FIGS. 3 and 4 are schematic views of a slider and a coil set moving relative to a magnet set of the charger of FIG. 1.

FIG. 5 shows the charger of FIG. 1 is charging and applied for a PDA.

FIG. 6 shows the charger of FIG. 1 is charging and applied for an electric torch.

### DESCRIPTION OF THE PREFERRED EMBODIMENTS

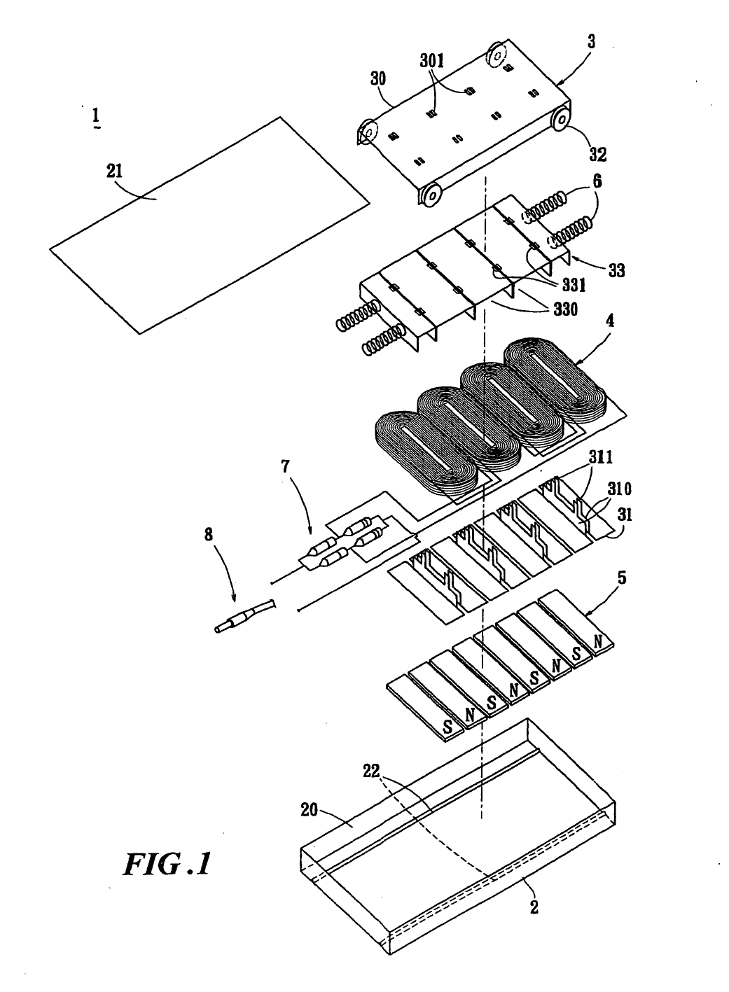

With reference to FIG. 1, a charger 1 comprises a casing 2, a slider 3, a coil set 4, a magnet set 5, and buffers 6. The casing 2 is flat and rectangular, and defines an opening 20 in a side thereof. A cover 21 envelops the opening 20. The slider 3, the coil set 4, the magnet set 5, and the buffers 6 are received in the casing 2. A pair of tracks 22 is formed on opposite sides of a bottom of the casing 2 for facilitating the slider 3 to move.

The slider 3 comprises a fixing plate 30, a metal base 31 and a rolling element 32. The metal base 31 is formed of steel. The fixing plate 30 defines a plurality of positioning slots 301 for assembling on the metal base 31. A plurality of shafts 310 is formed on the metal base 31, and each shaft 310 forms posts 311 at a top thereof for corresponding to the positioning slots 301. A metal sheet 33 cooperates with the metal base 31 and is sandwiched between the fixing plate 30 and the magnet set 5. The metal sheet 33 forms a plurality of partitions 330 for being sandwiched between the shafts 310. A plurality of holes 331 is defined in the metal sheet 33 for corresponding to the posts 311. In assembly, the posts 311 of the metal base 31 insert through the holes 331 and are then folded for retaining the metal sheet 33 onto the metal base 31.

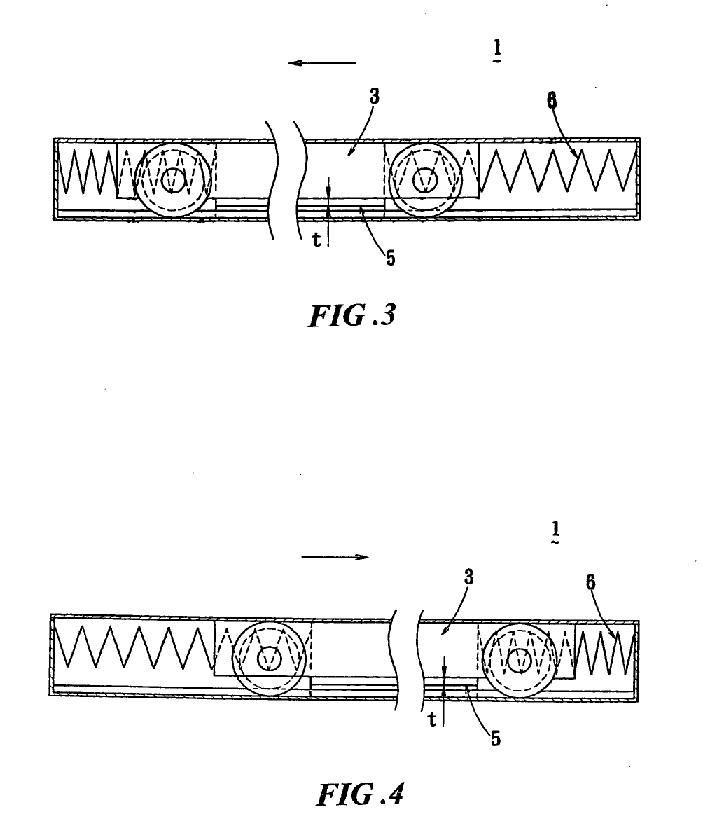

The coil set 4 has a plurality of coils surrounding shafts 310 of the metal base 31. The magnet set 5 has a plurality of magnets and glues to a bottom of the casing 2 along the line of North to South. The magnet set 5 is spaced a predetermined distance t from the slider 3 (As shown in FIGS. 3 and 4). The predetermined distance t is determined according to requirement of actual varying magnetic field. The buffers 6 are compressing springs and are located at opposite sides of a moving path of the slider 3 for urging the slider 3 to reset after displacement. The buffers 6 abut against the metal sheet 33 and lateral walls of the casing 2 in an embodiment of the present invention.

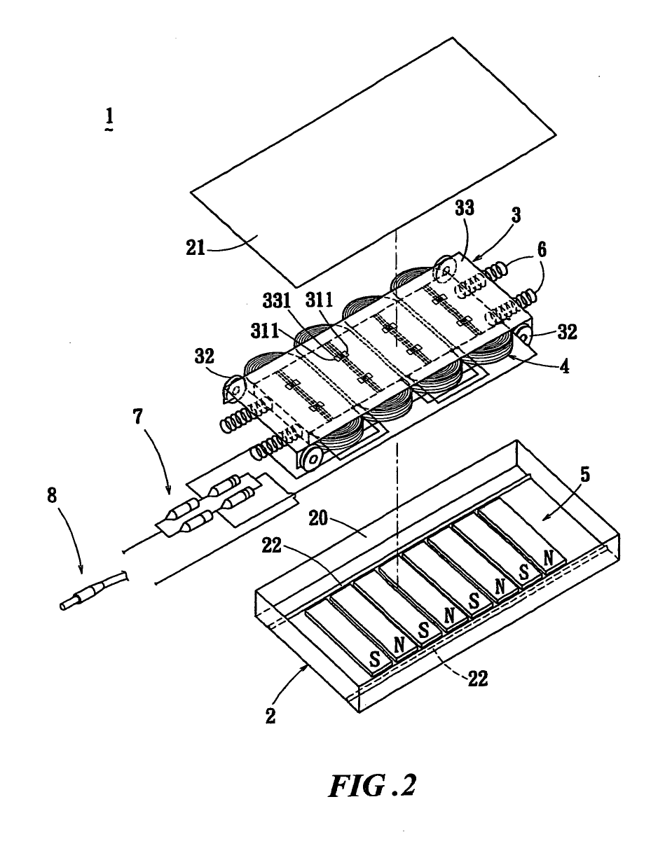

As shown in FIG. 2, in assembly, the magnet set 5 is mounted on a bottom of the casing 2. The magnet set 4 surrounds the shafts 310. The posts 311 of the metal base 31 are pulled through the holes 331 of the metal sheet 33 and then folded to retain the metal sheet 33 onto the metal base 31. The buffers 6 are received in the casing 2. Finally, the cover 21 envelops the opening 20 of the casing 2. The assembled charger 1 is flat and rectangular.

Referring to FIGS. 3 and 4, the slider 3 and the coil set 4 move relative to the magnet set 5. Along arrows shown in FIGS. 3 and 4, magnetic field around the coil set 4 varies quickly to produce inductive current for power. The buffers 6 provide resetting force for the slider 3, thereby urging the slider 3 to move back and forth. A commutating device 7 may be connected to the coil set 4 for avoiding unreliable inductive current. A plug cable 8 may connect the coil set 4 or the commutating device 7 with electronic products for providing power.

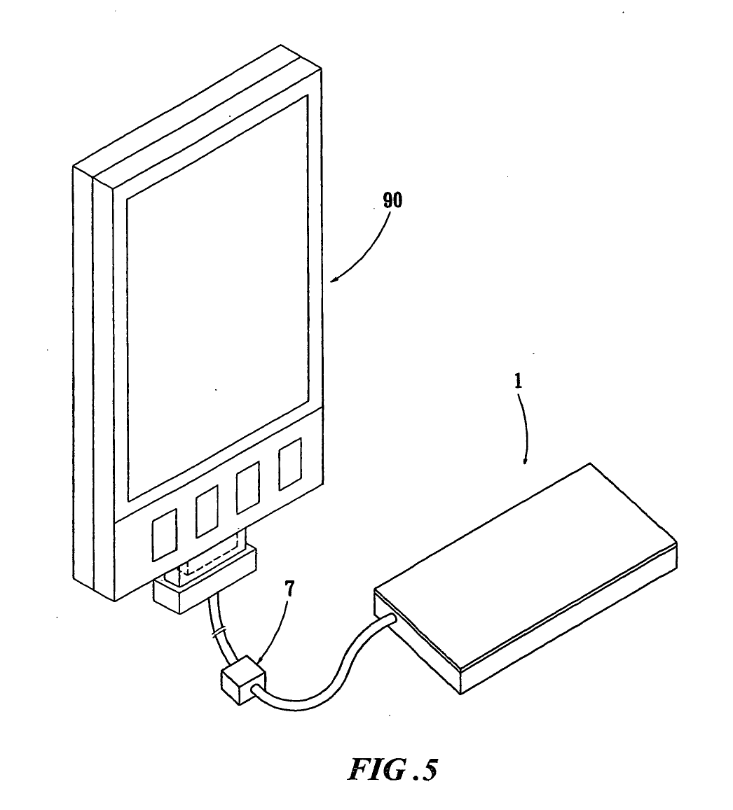

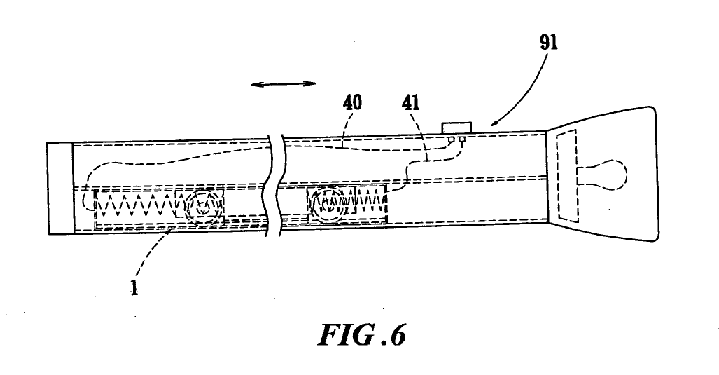

Referring to FIG. 5, the charger 1 is applied to a PDA 90. In use, a plug (not labeled) of the charger 1 is inserted onto a charging slot (not labeled) of the PDA 90. The charger 1 is moved to charge the PDA 90. Referring to FIG. 6, the charger 1 is assembled on an electric torch. Positive and negative electrodes of the charger 1 respectively connect with positive and negative electrodes of the electric torch 91. The charger 1 is moved to charge the electric torch 91. Similarly, the present invention can be applied for various electronic products, such as digital camera, Walkman and etc.

It is understood that the invention may be embodied in other forms without departing from the spirit thereof. Thus, the present examples and embodiments are to be considered in all respects as illustrative and not restrictive, and the invention is not to be limited to the details given herein.

1. A charger performing accelerated varying electromagnetic field to produce mass inductive current for power, comprising:
a separate casing defining an opening, a cover enveloping the opening;
a slider being received in the casing and including a fixing plate, a metal base assembled on a side of the fixing plate, and rolling elements on corners of the fixing plate, the metal base forming a plurality of shafts thereon;
a coil set being received in the casing and having a plurality of coils surrounding the shafts of the metal base;
a magnet set being assembled on a bottom of the casing and being spaced a predetermined distance from the slider, the magnet having a plurality of magnets; and
buffers being received in the casing and located at opposite sides of moving path of the slider for providing reset force of the slider after displacement;
wherein magnetic field varies quickly between coils of the coil set and magnets of the magnet set when the slider slides, thereby producing mass inductive current.

2. The charger as claimed in claim 1, wherein the metal base is formed of steel.

3. The charger as claimed in claim 2, wherein the fixing plate defines a plurality of positioning slots, and wherein each shaft of the metal base forms posts at a top thereof for corresponding to the positioning slots.

4. The charger as claimed in claim 3, further comprising a metal sheet cooperating with the metal base and being sandwiched between the fixing plate and the magnet set, the metal sheet forming a plurality of partitions for being sandwiched between the shafts of the metal base, and defining a plurality of holes for corresponding to the posts of the metal base.

5. The charger as claimed in claim 4, wherein the magnet set has a plurality of magnets and glues to a bottom of the casing along the line of North to South.

6. The charger as claimed in claim 5, wherein a pair of tracks is formed on opposite sides of a bottom of the casing for facilitating the slider to move.

7. The charger as claimed in claim 6, further comprising a commutating device is connected to the coil set for avoiding unreliable inductive current.

8. The charger as claimed in claim 7, wherein a plug cable connects the commutation device with electronic products for providing power.

9. A charger adapted for being assembled in a portable electronic product and electrically connecting with internal circuit of the portable electronic product, comprising:
a slider being received in the portable electronic product, and including a fixing plate, a metal base assembled on a side of the fixing plate, and rolling elements on corners of the fixing plate, the metal base forming a plurality of shafts thereon;
a coil set being received in the portable electronic product and having a plurality of coils surrounding the shafts of the metal base; and
a magnet set being received in the portable electronic product and being spaced a predetermined distance from the slider, the magnet having a plurality of magnets;
wherein magnetic field varies quickly between coils of the coil set and magnets of the magnet set when the slider slides, thereby producing mass inductive current.

10. The charger as claimed in claim 9, further comprising buffers received in the portable electronic product and located at opposite sides of moving path of the slider for providing reset force of the slider after displacement.

11. The charger as claimed in claim 10, wherein the metal base is formed of steel.

12. The charger as claimed in claim 11, wherein the fixing plate defines a plurality of positioning slots, and wherein each shaft of the metal base forms posts at a top thereof for corresponding to the positioning slots.

13. The charger as claimed in claim 12, further comprising a metal sheet cooperating with the metal base and being sandwiched between the fixing plate and the magnet set, the metal sheet forming a plurality of partitions for being sandwiched between the shafts of the metal base, and defining a plurality of holes for corresponding to the posts of the metal base.
